(19) United States
(12) Patent Application Publication
(10) Pub. No.: US 2017/0093172 A1
(43) Pub. Date: Mar. 30, 2017

(54) MULTIPLE-AXIS WIRELESS POWER RECEIVER

(71) Applicant: QUALCOMM Incorporated, San Diego, CA (US)

(72) Inventors: William Henry Von Novak, III, San Diego, CA (US); Seong Heon Jeong, San Diego, CA (US); Francesco Carobolante, San Diego, CA (US)

(21) Appl. No.: 14/866,326

(22) Filed: Sep. 25, 2015

(51) Int. Cl. H02J 5/00; H02J 7/02; H02J 17/00

(52) U.S. Cl. CPC H02J 5/005; H02J 17/00; H02J 7/025

(57) ABSTRACT

Disclosed is an electronic device comprising a plurality of power receiving elements. Each power receiving element may be configured to electromagnetically couple to an externally generated magnetic field to receive power wirelessly. A plurality of switches may be connected to the plurality of power receiving elements. An output circuit may provide wirelessly received power to the electronic device. The plurality of switches may be configured to selectively short circuit at least one of the plurality of power receiving elements.

### TECHNICAL FIELD

The present disclosure relates generally to wireless power transfer, and more particularly to a wireless power receiver having configurable receive coils oriented on different axes.

### BACKGROUND

Wireless power transfer is an increasingly popular capability in portable electronic devices, such as mobile phones, computer tablets, etc. because such devices typically require long battery life and low battery weight. The ability to power an electronic device without the use of wires provides a convenient solution for users of portable electronic devices. Wireless power charging systems, for example, may allow users to charge and/or power electronic devices without physical, electrical connections, thus reducing the number of components required for operation of the electronic devices and simplifying the use of the electronic device.

Wireless power transfer allows manufacturers to develop creative solutions to problems due to having limited power sources in consumer electronic devices. Wireless power transfer may reduce overall cost (for both the user and the manufacturer) because conventional charging hardware such as power adapters and charging chords can be eliminated. There is flexibility in having different sizes and shapes in the components (e.g., magnetic coil, charging plate, etc.) that make up a wireless power transmitter and/or a wireless power receiver in terms of industrial design and support for a wide range of devices, from wearable devices to mobile handheld devices to computer laptops.

### SUMMARY

Aspects of the present disclosure include an electronic device having power receiving elements configured to electromagnetically couple to an externally generated magnetic field to receive power wirelessly. Switches connected to the power receiving elements may be configured to selectively short circuit at least one of the plurality of power receiving elements.

In some aspects, some of the power receiving elements may be arranged in different geometric planes.

In some aspects, one of the power receiving elements may have an orientation to electromagnetically couple more strongly to an externally generated magnetic field having field lines in a first orientation than to an externally generated magnetic field having field lines in a second orientation.

In some aspects, the device may be a handheld device. One of the power receiving elements may be disposed on a major surface of the handheld device and one of the power receiving elements may be disposed on a side surface of the handheld device.

In some aspects, the device may be a wearable device. One of the power receiving elements may be disposed on a face of the wearable device and one of the power receiving elements may be disposed on a fastener of the wearable device.

In some aspects, the power receiving elements may be connected in series.

In some aspects, at least one power receiving element may be short circuited to a ground reference.

In some aspects, a controller may operate the switches. In some aspects, the controller may be configured to communicate with a source of an externally generated magnetic field to operate the switches as a consequence of the communication.

In some aspects, a voltage sensor may detect an output voltage. The controller may be configured to select one or more of the power receiving elements to short circuit depending on which combination of the power receiving elements provides the highest output voltage.

In some aspects, a tuning circuit may be electrically connected to the power receiving elements to define a resonator.

In some aspects, a resonator and a rectifier circuit electrically connected to the resonator may produce a rectified output.

In some aspects, each power receiving element may be a coil of electrically conductive material.

Aspects of the present disclosure include a method for receiving power wirelessly in an electronic device. The method may include selecting one or more first power receiving elements from a plurality of series-connected power receiving elements disposed in the electronic device and selecting one or more second power receiving elements from the plurality of series-connected power receiving elements. The method may further include electromagnetically coupling the one or more first power receiving elements to an externally generated magnetic field to receive power wirelessly including inducing a flow of current in the one or more first power receiving elements with the externally generated magnetic field and bypassing the flow of current around the one or more second power receiving elements. The method may include providing wirelessly received power received by the one or more first power receiving elements to the electronic device.

In some aspects, the method may include communicating with a source of the externally generated magnetic field to determine an orientation of the externally generated magnetic field. The one or more first power receiving elements and one or more second power receiving elements may be selected based on the orientation of the externally generated magnetic field.

In some aspects, selecting the one or more first power receiving elements may include determining that the one or more first power receiving elements produces the most power among the plurality of power receiving elements.

In some aspects, the method may include shorting together the one or more second power receiving elements.

In some aspects, the plurality of power receiving elements may include a plurality of coils, some of which are arranged in different geometric planes.

Aspects of the present disclosure include an electronic device having a first power receiving element configured to electromagnetically couple to a first type of externally generated magnetic field having a first orientation to receive power wirelessly. A second power receiving element may be configured to electromagnetically couple to the first type of externally generated magnetic field, to receive power wirelessly. A third power receiving element may be configured to electromagnetically couple to a second type of externally generated magnetic field having a second orientation, to receive power wirelessly. The third power receiving element may be connected in series with the first and second power receiving elements. Switches may selectively ground one end of the first power receiving element or the second power receiving element to reduce re-radiation of a magnetic field by the third power receiving element when in the presence of the first type of externally generated magnetic field.

In some aspects, the first and second power receiving elements may electromagnetically couple more strongly to the first type of externally generated magnetic field than to the second type of externally generated magnetic field. The third power receiving element may electromagnetically couple more strongly to the second type of externally generated magnetic field than to the first type of externally generated magnetic field.

In some aspects, the first and second power receiving elements may be arranged in geometric planes different from the third power receiving element.

In some aspects, the third power receiving element may be electrically connected between the first and second power receiving elements.

In some aspects, the electronic device may be a handheld device. The first and second power receiving elements may be arranged on sides of the handheld device and the third power receiving element may be arranged on a major surface of the handheld device.

In some aspects, the electronic device may be a wearable device. The first and second power receiving elements may be arranged on a fastener of the wearable device and the third power receiving element may be arranged on a face of the wearable device.

Aspects of the present disclosure include a method for receiving power wirelessly in an electronic device. The method may include electromagnetically coupling a first power receiving element and a second power receiving element to an externally generated magnetic field to receive power wirelessly. A third power receiving element may electromagnetically couple to the externally generated magnetic field. The first and second power receiving elements may electromagnetically couple more strongly to the externally generated magnetic field than does the third power receiving element. Current induced in the first power receiving element may be prevented from producing a flow of current in the third power receiving element to reduce re-radiation in the third power receiving element.

In some aspects, the method may include closing a switch connected between one end of the first power receiving element and a ground potential to prevent the current induced in the first power receiving element from producing a flow of current in the third power receiving element.

In some aspects, the method may include allowing a current induced in the second power receiving element to produce a flow of current in the third power receiving element, wherein the current induced in the first power receiving element is greater than the current induced in the second power receiving element. The method may further include opening a switch connected between one end of the second power receiving element and a ground potential to allow the current induced in the second power receiving element to produce a flow of current in the third power receiving element.

In some aspects, the third power receiving element may be connected in series between the first and second power receiving elements, the method may further include grounding one end of the first power receiving element to prevent the current induced in the first power receiving element from producing a flow of current in the third power receiving element.

The following detailed description and accompanying drawings provide a better understanding of the nature and advantages of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. In the accompanying drawings:

FIG. 1 is a functional block diagram of a wireless power transfer system in accordance with an illustrative embodiment.

FIG. 2 is a functional block diagram of a wireless power transfer system in accordance with an illustrative embodiment.

FIG. 3 is a schematic diagram of a portion of transmit circuitry or receive circuitry of FIG. 2 including a power transmitting or receiving element in accordance with an illustrative embodiment.

FIG. 4 illustrates an example of power receiving elements in a wireless power receiving unit.

FIGS. 5A and 5B illustrate an example of power receiving elements in a wearable electronic device.

FIGS. 6 and 6A illustrate an example of wireless power charging that uses a vertical charging field.

FIGS. 7 and 7A illustrate an example of wireless power charging that uses a horizontal charging field.

FIG. 8 is a circuit diagram illustrating an example of a resonator.

FIG. 9 is a circuit diagram illustrating an example of diode OR'd resonators.

FIGS. 10 and 10A illustrate switching configurations in accordance with some embodiments of the present disclosure.

FIGS. 10A-1 and 10A-2 illustrate different configuration states of the switching configuration shown in FIG. 10A.

FIGS. 11 and 11A illustrate switching configurations in accordance with some embodiments of the present disclosure.

FIG. 12 illustrates a hybrid configuration in accordance with some embodiments of the present disclosure.

FIGS. 12A, 12B, and 12C illustrate different configuration states of the hybrid configuration shown in FIG. 12.

### DETAILED DESCRIPTION

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “power receiving element” to achieve power transfer.

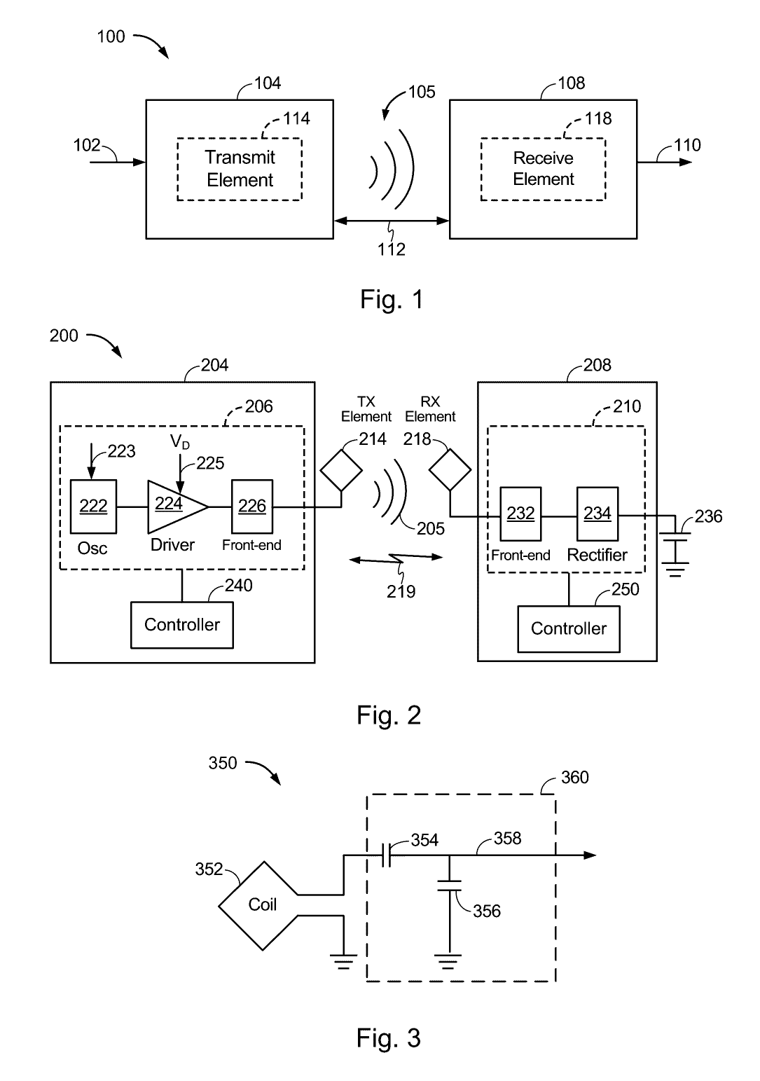

FIG. 1 is a functional block diagram of a wireless power transfer system 100, in accordance with an illustrative embodiment. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) coupled to the output power 110. The transmitter 104 and the receiver 108 may be separated by a distance 112. The transmitter 104 may include a power transmitting element 114 for transmitting/coupling energy to the receiver 108. The receiver 108 may include a power receiving element 118 for receiving or capturing/coupling energy transmitted from the transmitter 104.

In one illustrative embodiment, the transmitter 104 and the receiver 108 may be configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over larger distances. Resonant inductive coupling techniques may thus allow for improved efficiency and power transfer over various distances and with a variety of inductive power transmitting and receiving element configurations.

In certain embodiments, the wireless field 105 may correspond to the “near field” of the transmitter 104. The near-field may correspond to a region in which there are strong reactive fields resulting from the currents and charges in the power transmitting element 114 that minimally radiate power away from the power transmitting element 114. The near-field may correspond to a region that is within about one wavelength (or a fraction thereof) of the power transmitting element 114.

In certain embodiments, efficient energy transfer may occur by coupling a large portion of the energy in the wireless field 105 to the power receiving element 118 rather than propagating most of the energy in an electromagnetic wave to the far field.

In certain implementations, the transmitter 104 may output a time varying magnetic (or electromagnetic) field with a frequency corresponding to the resonant frequency of the power transmitting element 114. When the receiver 108 is within the wireless field 105, the time varying magnetic (or electromagnetic) field may induce a current in the power receiving element 118. As described above, if the power receiving element 118 is configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge or to power a load.

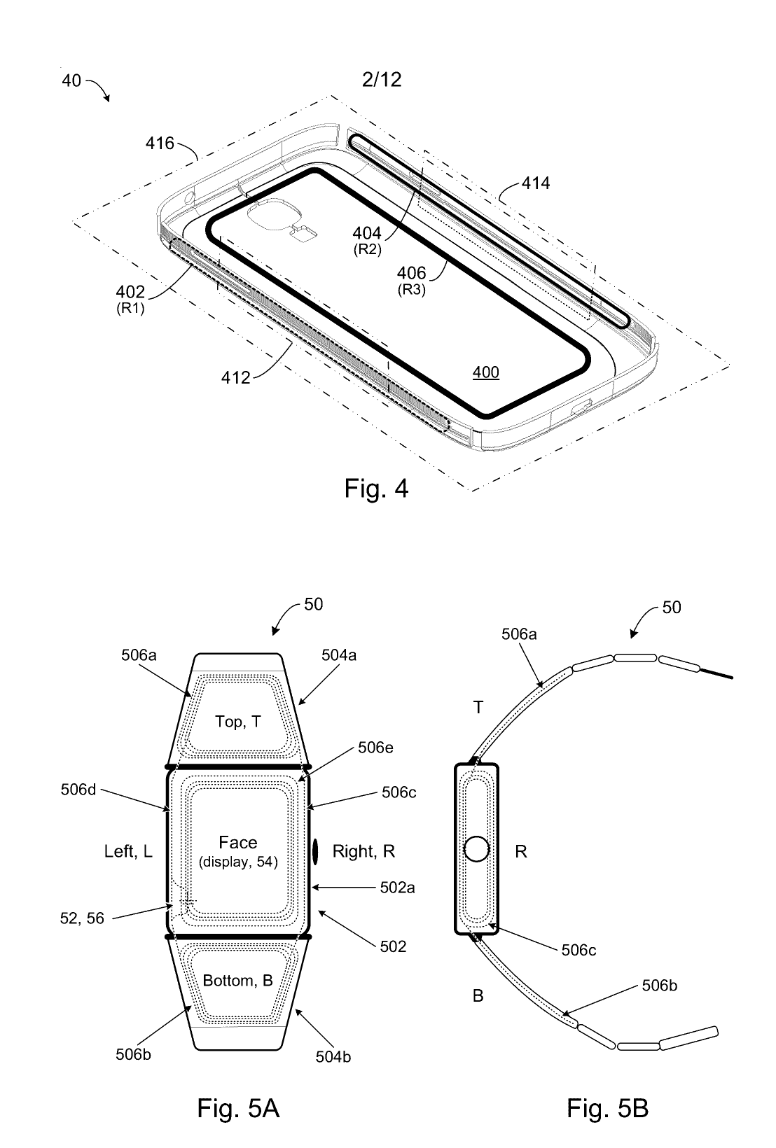

FIG. 2 is a functional block diagram of a wireless power transfer system 200, in accordance with another illustrative embodiment. The system 200 may include a transmitter 204 and a receiver 208. The transmitter 204 (also referred to herein as power transfer unit, PTU) may include transmit circuitry 206 that may include an oscillator 222, a driver circuit 224, and a front-end circuit 226. The oscillator 222 may be configured to generate an oscillator signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or otherwise powering a load.

The transmitter 204 may further include a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by it. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) may include receive circuitry 210 that may include a front-end circuit 232 and a rectifier circuit 234. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 2. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. In certain embodiments, the transmitter 204 may be configured to generate a predominantly non-radiative field with a direct field coupling coefficient (k) for providing energy transfer. Receiver 208 may directly couple to the wireless field 205 and may generate an output power for storing or consumption by a battery (or load) 236 coupled to the output or receive circuitry 210.

The receiver 208 may further include a controller 250 configured similarly to the transmit controller 240 as described above for managing one or more aspects of the wireless power receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to minimize transmission losses between the transmitter 204 and the receiver 208.

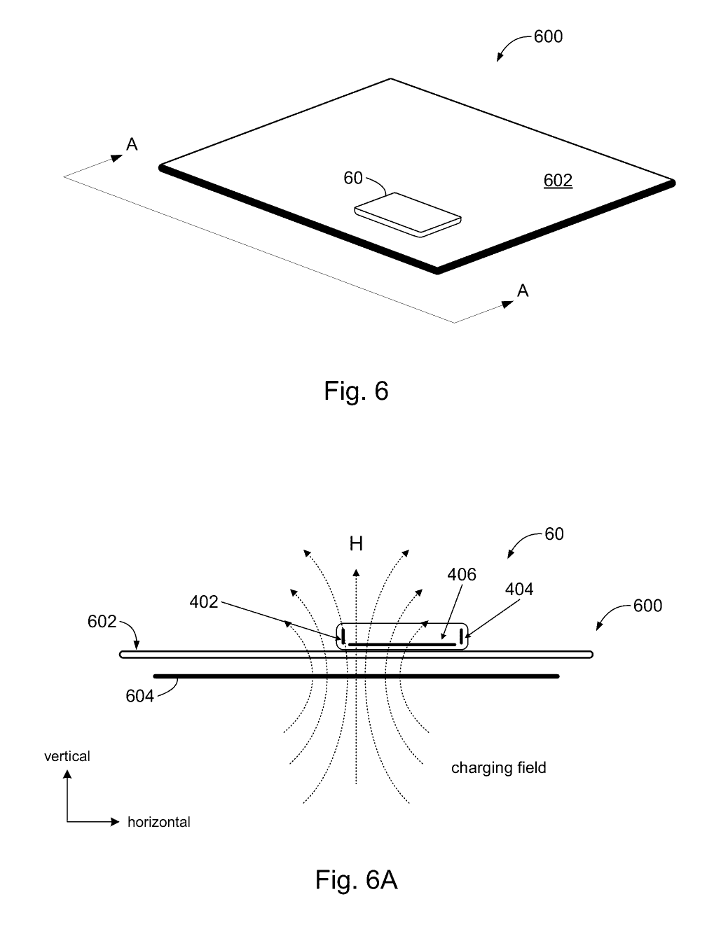

FIG. 3 is a schematic diagram of a portion of the transmit circuitry 206 or the receive circuitry 210 of FIG. 2, in accordance with illustrative embodiments. As illustrated in FIG. 3, transmit or receive circuitry 350 may include a power transmitting or receiving element 352 and a tuning circuit 360. The power transmitting or receiving element 352 may also be referred to or be configured as an antenna or a “loop” antenna. The term “antenna” generally refers to a component that may wirelessly output or receive energy for coupling to another antenna. The power transmitting or receiving element 352 may also be referred to herein or be configured as a “magnetic” antenna, or an induction coil, a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown in this figure).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non limiting example, the tuning circuit 360 may comprise a capacitor 354 and a capacitor 356, which may be added to the transmit and/or receive circuitry 350 to create a resonant circuit.

The tuning circuit 360 may include other components to form a resonant circuit with the power transmitting or receiving element 352. As another non limiting example, the tuning circuit 360 may include a capacitor (not shown) placed in parallel between the two terminals of the circuitry 350. Still other designs are possible. In some embodiments, the tuning circuit in the front-end circuit 226 may have the same design (e.g., 360) as the tuning circuit in front-end circuit 232. In other embodiments, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, persons of ordinary skill will appreciate that aspects disclosed herein may be used in non-resonant implementations for wireless power transfer.

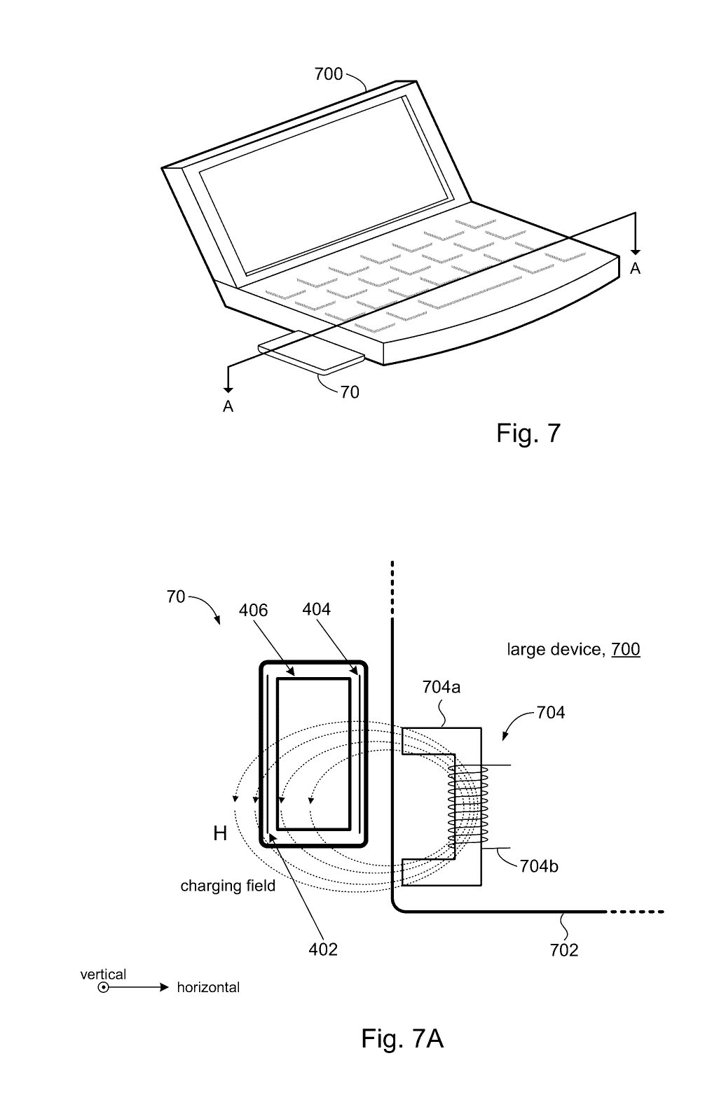

FIG. 4 shows the casing portion 400 of an electronic device 40, and in particular an arrangement of power receiving elements 402, 404, 406 in the casing portion 400. The electronic device 40 may be a smartphone, a computer tablet, a digital camera, and so on. The casing potion 400, for example, may be the back cover of the electronic device 40. For illustrative purposes and without loss of generality, the casing portion 400 shown in FIG. 4 represents the back cover of a handheld device such as a smartphone.

FIG. 4 shows an illustrative arrangement of power receiving elements 402, 404, 406 within the casing portion 400. In some embodiments, the power receiving elements 402, 404, 406 may be of any suitable electrically conductive material such as, but not limited to, copper wire, traces patterned on flexible substrates, combinations thereof, and so on. For example, the power receiving elements 402, 404, 406 may be coils of wire or electrically conductive traces formed on a flexible printed circuit board (FPCB) in the shape of coils or other suitable shape.

Depending on the specific configuration of the casing portion 400, the power receiving elements 402, 404, 406 may lie in different geometric planes. The casing portion 400 shown in FIG. 4, for example, has a generally rectilinear shape. The power receiving element 406 may lie in a (horizontal) plane 416 defined by a bottom (major) surface of the casing portion 400. The power receiving element 402, likewise, may lie in a (vertical) plane 412 defined by a side surface of the casing portion 400. Similarly, the power receiving element 404 may lie in a (vertical) plane 414 defined by another side surface of the casing portion 400. The (horizontal) power receiving element 406 may be substantially perpendicular in relation to (vertical) power receiving elements 402 and 404, or in other embodiments, at some angle in between.

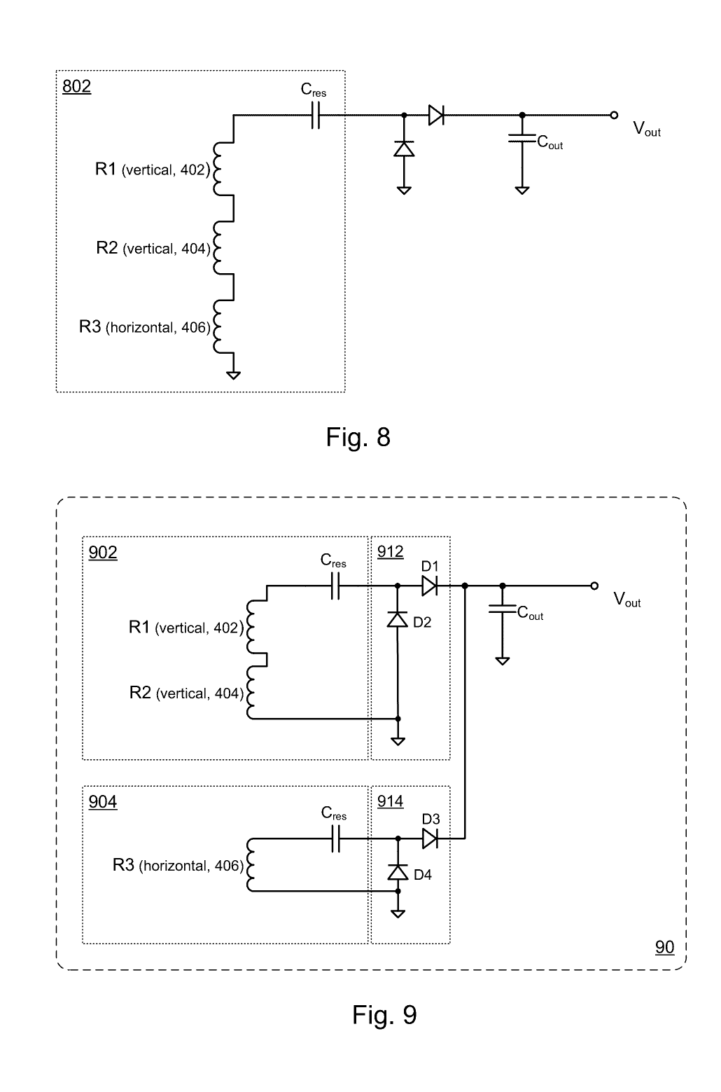

FIGS. 5A and 5B show another arrangement of power receiving elements that can be incorporated in embodiments of the present disclosure. FIGS. 5A and 5B show an arrangement of power receiving elements 506a, 506b, 506c, 506d, 506e in a wearable device 50. The wearable device 50 may be a watch, an electronic fitness monitoring device (e.g., fitness tracker, body sensor, etc.), an electronic bracelet, an electronic badge, and so on. The wearable device 50 may include a device body 502, to house components of the wearable device 50, including for example, device electronics 52 (e.g., processor, controllers, communications, etc.), a display 54, power electronics 56 (e.g., battery charger, power management unit, etc.), and so on. Portions of the wearable device 50 may be configured to fasten the wearable device 50 to the user. In some embodiments, for example, fasteners 504a, 504b may be provided to allow the user to fasten the wearable device 50 to themselves. A watch, for example, may include straps that allow the user to fasten the watch to their wrist. A wearable electronic badge may include a clip of other suitable mechanism that allows the user to fasten the badge to their clothing, and so on.

The wearable device 50 may comprise power receiving elements 506a-506e arranged on different parts of the wearable device 50. The power receiving elements 506a-506e may be of any suitable electrically conductive material such as, but not limited to, copper wire, traces patterned on flexible substrates, combinations thereof, and so on. The power receiving elements 506a-506e may be coils of wire, electrically conductive traces formed on a flexible printed circuit board in the shape of coils, and so on.

The power receiving elements 506a-506e may be disposed in, incorporated in, or otherwise integrated with the components of the wearable device 50. For example, FIG. 5A shows that a top-side power receiving element 506a may be integrated with a portion of the top fastener 504a. The top-side power receiving element 506a is represented in FIG. 5A by dotted lines to indicate that the power receiving element may be embedded within the material of the top fastener 504a. The right-side view of FIG. 5B indicates this more clearly. Similarly, a bottom-side power receiving element 506b may be integrated with a portion of the bottom fastener 504b. In other embodiments, the top-side power receiving element 506a and bottom-side power receiving element 506b may be affixed on a surface of respective top fastener 504a and bottom fastener 504b, for example, using a suitable adhesive. In other embodiments, the top-side power receiving element 506a and bottom-side power receiving element 506b may be affixed within the material of top fastener 504a and bottom fastener 504b.

One or more power receiving elements 506c, 506d may be affixed to or otherwise integrated with the device body 502 of the wearable device 50. For example, the device body 502 may contain a right-side power receiving element 506c and a left-side power receiving element 506d. In some embodiments, the right-side power receiving element 506c and left-side power receiving element 506d may be affixed to respective inside surfaces of housing 502a of the device body 502. FIG. 5B illustrates more clearly the right-side power receiving element 506c disposed within the device body 502. A power receiving element 506e may be arranged on the display 54 (face) of the wearable device 50; e.g., a coil wound around the periphery of the display 54.

The power receiving elements 506a-506e of the wearable device 50 may be arranged at different angles relative to each other in three dimensions. In some embodiments, for example, each power receiving element 506a, 506b may lie along geometric planes (not shown) that are different from planes (not shown) on which power receiving elements 506c-506e lie.

Going forward, the configuration of power receiving elements 402, 404, 406 shown in FIG. 4 will be used as an illustrative example to describe aspects of the present disclosure. Elements introduced in FIG. 4 that appear in subsequent figures may be identified by the same reference numbers. Persons of ordinary skill will appreciate that various embodiments in accordance with the present disclosure may include configurations of power receiving elements (e.g., 506a-506e, FIG. 5A) other than illustrated in FIG. 4.

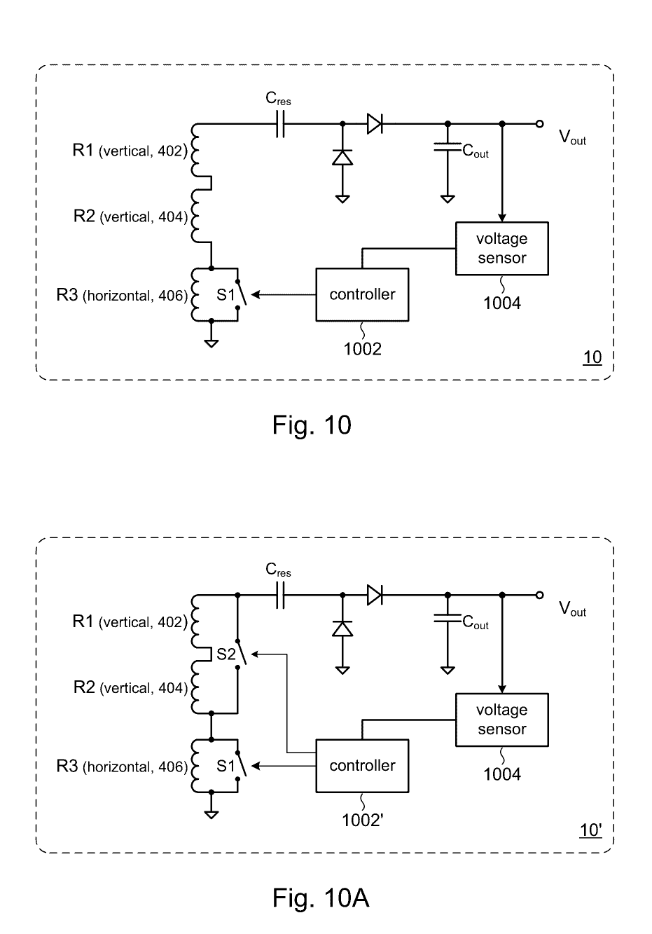

In some wireless power systems, the magnetic field can come from a power transmitting element (e.g., charging coil) that lies in the horizontal plane, and wound such that the field lines of the resulting magnetic field are largely vertical relative to a plane defining the charging surface. FIGS. 6 and 6A, for example, show a receiver 60 placed on a charging surface 602 of a wireless power transfer system 600. The receiver 60 may be an electronic device such as a smartphone, computer tablet, wearable device (e.g., 50, FIG. 5A), and so on. FIG. 6A shows a cross-sectional view taken along view line A-A in FIG. 6.

FIG. 6A shows that the wireless power transfer system 600 may include a power transmitting element 604 configured to generate a magnetic field H (charging field). The power transmitting element 604 may be may of any suitable electrically conductive material such as, but not limited to, copper wire, traces patterned on flexible substrates, combinations thereof, and so on. The power transmitting element 604 may be a coil of wire, an electrically conductive trace formed on a flexible printed circuit board in the shape of a coil, and so on. FIG. 6A shows that the magnetic field H generated by power transmitting element may be a type that comprises field lines having a largely vertical orientation near the charging surface 602.

Merely as an example, suppose the receiver 60 comprises the casing 400 shown in FIG. 4 having power receiving elements 402, 404, 406. As such, the largely vertically oriented field lines of magnetic field H can intersect the horizontal power receiving element 406. Accordingly, the horizontal power receiving element 406 may (electromagnetically) couple more strongly to the magnetic field H may than would the vertical power receiving elements 402, 404. As such, the current induced in the horizontal power receiving element 406 may be greater that the current induced in the vertical power receiving elements 402, 404. If the power receiving elements 402, 404, 406 are connected together, for example to provide an output voltage, then the higher induced current flow in power receiving element 406 can produce a flow of current in power receiving elements 402, 404. The flow of current in power receiving elements 402, 404 can result in re-radiation of magnetic fields (not shown) from power receiving elements 402, 404. This may be undesirable if the re-radiated magnetic fields point toward a user, or if the re-radiated magnetic fields interfere with nearby electronic devices (not shown), and so on.

Nevertheless, having multiple power receiving elements (e.g., 402, 404, 406) configured in different geometric planes can be beneficial. Merely to illustrate a point, suppose the receiver 60 is a small irregular device such as a wearable device (e.g., 50, FIGS. 5A, 5B). The receiver 60 may comprise power receiving elements (e.g., 506a-506e, FIGS. 5A, 5B) that may be configured in various different geometric planes. Consider, for example, wearable device 50 (FIGS. 5A, 5B) having power receiving elements 506a-506e configured in various different geometric planes. For any given placement orientation of wearable device 50 on the charging surface 602, some of the power receiving elements 506a-506e can (electromagnetically) couple to magnetic field H more strongly than would the others of the power receiving elements 506a-506e. The several plane orientations of power receiving elements 506a-506e, therefore, allow a user to place the wearable device 50 on the charging surface 602 in several orientations and still perform wireless power transfer.

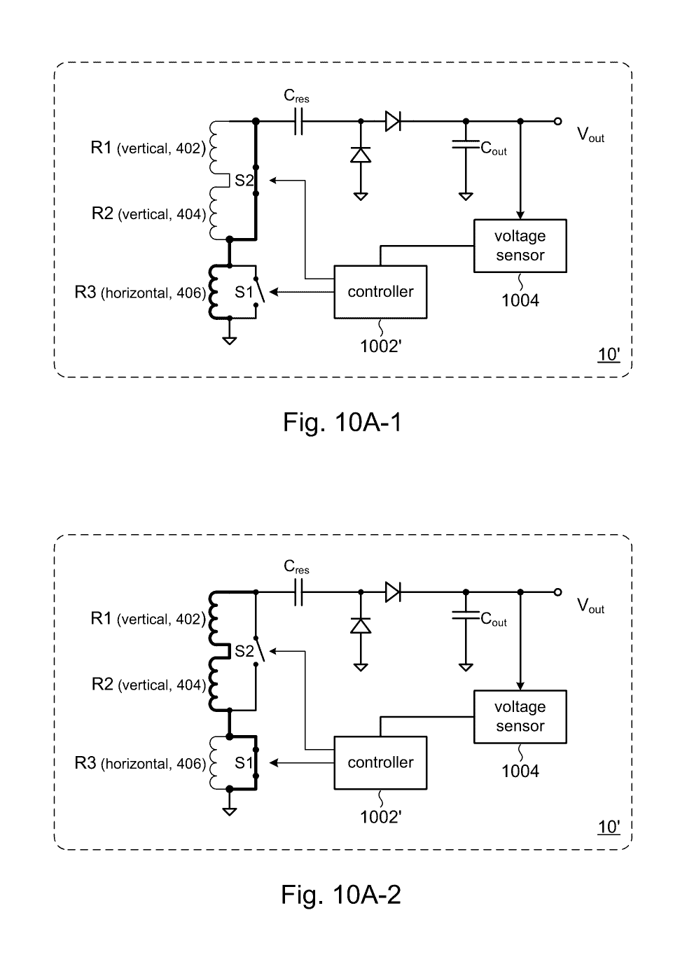

FIG. 6 shows that, in some wireless power systems, the power transmitting element 604 may generally generate a vertically oriented magnetic field H. Referring to FIGS. 7 and 7A, in other wireless power systems, the magnetic field H may come from a power transmitting element 704 that lies in the vertical plane such that the field lines of the resulting magnetic field H are largely horizontal. This configuration may be suitable, for example, in a wireless power system that sits on top of a table and charges a device placed next to the charger. FIGS. 7 and 7A, illustrate an example of a side-charging configuration comprising a larger electronic device 700 that may include a wireless power transfer system and a smaller receiver (receiver) 70. The receiver 70 may be placed next to the larger electronic device 700. The receiver 70 may be an electronic device such as a smartphone, computer tablet, wearable device (e.g., 50, FIG. 5A), and so on.

FIG. 7A shows a cutaway view taken along view line A-A in FIG. 7. FIG. 7A shows that the larger electronic device 700 may include a housing 702 to house the electronic components including a power transmitting element 704 configured to generate a magnetic field H (charging field). The power transmitting element 704, for example, may include a core 704a and a coil of insulated wire 704b wound about the core 704a. FIG. 7A shows a coil of wire 704b that has a vertical orientation relative to a surface (not shown) on which the larger electronic device 700 and receiver 70 might be placed. The magnetic field H generated by power transmitting element 704 may be of a type that has field lines having a largely horizontal orientation relative to the surface of a table (not shown).

Merely as an example, suppose the receiver 70 comprises the casing 400 shown in FIG. 4 having power receiving elements 402, 404, 406. As such, the horizontally oriented field lines of magnetic field H may intersect the vertical power receiving elements 402, 404 for a given orientation of receiver 70; for example, when the receiver 70 is lying flat next to the larger electronic device 700, as depicted in FIG. 7A. Accordingly, the vertical power receiving elements 402, 404 may couple to the magnetic field H more strongly than would the horizontal power receiving element 406. As such, the current induced in the vertical power receiving elements 402, 404 may be greater than the current induced in the horizontal power receiving element 406. If the power receiving elements 402, 404, 406 are connected together, for example to provide an output voltage, then the higher induced current flows in power receiving elements 402, 404 can produce a flow of current in power receiving element 406. The flow of current in power receiving element 406 can result in re-radiation of magnetic fields (not shown) from power receiving element 406. This may be undesirable if the re-radiated magnetic fields point toward a user sitting at the table.

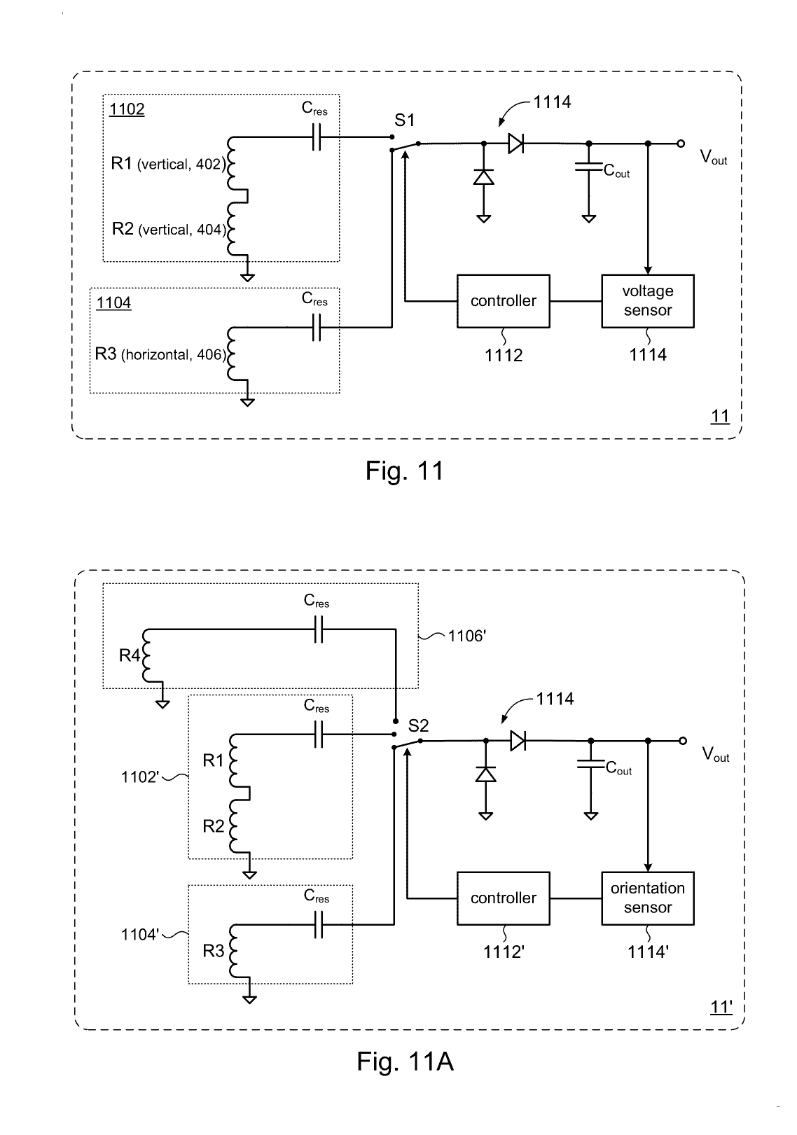

FIG. 8 is a circuit schematic that represents an arrangement of power receiving elements R1, R2, R3 that may constitute a power component 802 to provide an output voltage at Vₒᵤₜ. In some embodiments, the power receiving elements R1, R2, R3 may represent the inductors of respective power receiving elements 402, 404, 406 shown in FIG. 4. Power component 802 may include a tuning circuit Cᵣₑₛ to define a resonant circuit. It will be appreciated that the tuning circuit may comprise elements (e.g., reactive elements) in addition to, or in place of, Cᵣₑₛ. In other embodiments, power component 802 may be a non-resonant implementation. Accordingly, in some embodiments the tuning circuit Cᵣₑₛ may be omitted.

As explained above, in a vertical charging field (e.g., FIG. 6A), a larger current may be induced in the horizontal power receiving element 406 (R3) than in the vertical power receiving elements 402, 404 (R1, R2). FIG. 8 shows that the larger flow of induced current in horizontal power receiving element 406 can produce a flow of current in the vertical power receiving elements 402, 404, and so re-radiation from power receiving elements 402, 404 can result. Similarly, in a horizontal charging field (e.g., FIG. 7A), a larger current may be induced in the vertical power receiving elements 402, 404 (R1, R2) than in horizontal power receiving element 406. FIG. 8 shows that the larger flow of induced current in the vertical power receiving elements 402, 404 can produce a flow of current in the horizontal power receiving element 406, and so re-radiation from horizontal power receiving element 406 can result.

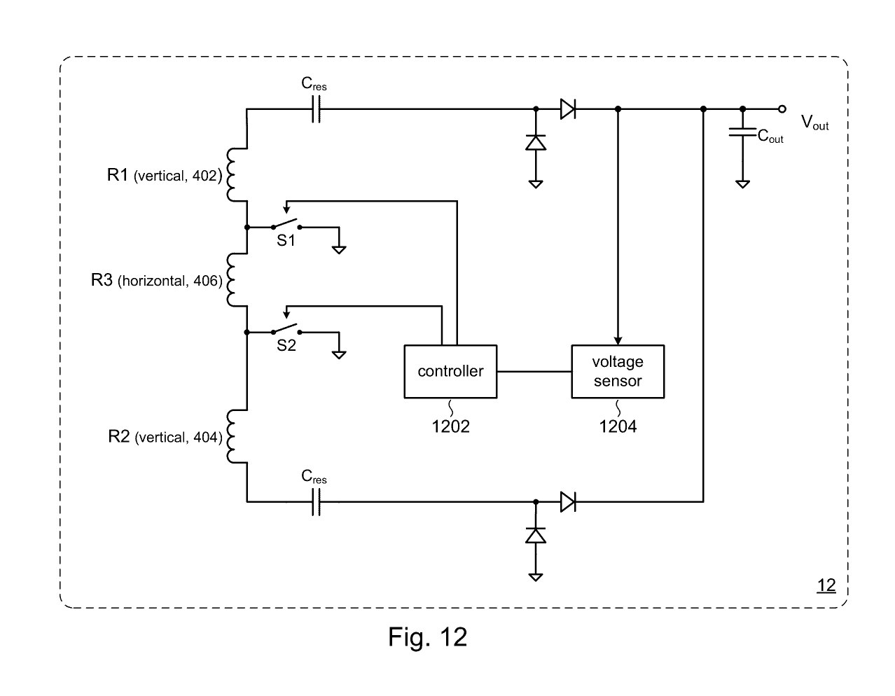

In accordance with the present disclosure, the power receiving elements 402, 404, 406 may be arranged in sections. FIG. 9, for example, shows a receiver 90 having a configuration of power receiving elements 402, 404, 406 in which the horizontal power receiving element 406 and the vertical power receiving elements 402, 404 may both be connected at the output Vₒᵤₜ, but electrically isolated from each other. In a particular embodiment, the configuration may include a first power component 902 comprising the vertical power receiving elements 402, 404 and a tuning circuit Cᵣₑₛ. It will be appreciated that the tuning circuit may comprise elements (e.g., reactive elements) in addition to, or in place of, Cᵣₑₛ. Although in some embodiments, the first power component 902 may comprise a resonant circuit for wireless power transfer, persons of ordinary skill will appreciate that other embodiments may use non-resonant implementations for wireless power transfer. Accordingly, in some embodiments, the tuning circuit Cᵣₑₛ may be omitted.

The first power component 902 may be electrically connected to a rectifier circuit 912 to provide a rectified output to an output circuit. In some embodiments, the rectifier circuit 912 may comprise diodes D1, D2. In other embodiments, the rectifier circuit 912 may be a synchronous rectifier including one or more switches. The output circuit may comprise a smoothing capacitor Cₒᵤₜ to produce an output voltage at Vₒᵤₜ.

The configuration may further include a second power component 904 comprising the horizontal power receiving element 406 and a tuning circuit Cᵣₑₛ, although in other embodiments the tuning circuit may comprise elements (e.g., reactive elements) in addition to, or in place of, Cᵣₑₛ. In some embodiments, the second power component 904 may comprise a resonant circuit for wireless power transfer. However, persons of ordinary skill will appreciate that other embodiments may use non-resonant implementations for wireless power transfer. Accordingly, in some embodiments the tuning circuit Cᵣₑₛ may be omitted.

The second power component 904 may be electrically connected to a rectifier circuit 914 to provide a rectified output to smoothing capacitor Cₒᵤₜ. In some embodiments, for example, the rectifier circuit 914 may comprise diodes D3, D4. In other embodiments, the rectifier circuit 914 may be a synchronous rectifier including one or more switches.

The rectifier circuits 912, 914 can electrically isolate their respective power components 902, 904 from each other (diode OR'ing). The rectifier circuit 912, for example, can prevent induced current in the vertical power receiving elements 402, 404 from creating a flow of current in the horizontal power receiving element 406. In this way, induced current in vertical power receiving elements 402, 404 can be prevented from producing re-radiated magnetic fields emanating from horizontal power receiving element 406. Similarly, the rectifier circuit 914 can prevent induced current in the horizontal power receiving element 406 from creating of flow of current in the vertical power receiving elements 402, 404. In this way, induced current in horizontal power receiving element 406 can be prevented from producing re-radiation of magnetic fields from vertical power receiving elements 402, 404.

In operation, the power receiving element(s) that have the most induced current can contribute most of the power at the output Vₒᵤₜ. For example, in a predominantly vertical charging field (e.g., FIG. 6A), the horizontal power receiving element 406 may couple more strongly to the charging field than would the vertical power receiving elements 402, 404. Accordingly, the horizontal power receiving element 406 may experience the most induced current and so the output voltage at rectifier circuit 914 would be greater than at rectifier 912 (effectively reverse biasing diodes D1, D2). Likewise, in a predominantly horizontal charging field (e.g., FIG. 7A), the vertical power receiving elements 402, 404 may experience the most induced current and so the output voltage at rectifier circuit 912 would be greater than at rectifier 914 (effectively reverse biasing diodes D3, D4).

In some cases, the power receiving elements 402, 404, 406 may experience a similar amount of coupling to the charging field, in which case both rectifiers 912, 914 may provide power to the output Vₒᵤₜ. For example, a wearable device (e.g., FIG. 5A) may lie at an angle relative to the charging field (e.g., FIGS. 6A, 7A) such that the power receiving elements (e.g. 506a-506e, FIG. 5A) intersect the charging field at angles less than 90°. Accordingly, no one power receiving element 506a-506e will be maximally coupled to the charging field. The amount of coupling with the charging field will depend on the angle of a given power receiving element 506a-506e relative to the charging field.

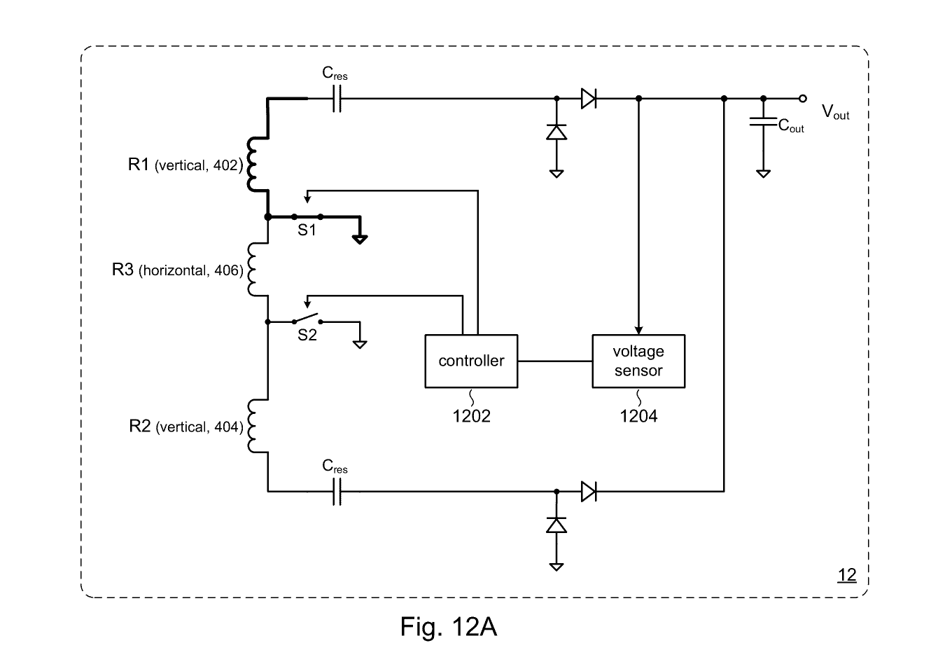

In accordance with the present disclosure, the power receiving elements 402, 404, 406 may be arranged in sections that can be selectively short circuited using active devices. FIG. 10, for example, shows a receiver 10 having a configuration of power receiving elements 402, 404, 406 in accordance with some embodiments. For example, the power receiving elements 402, 404, 406 may be series-connected. A switch S1 may be provided across power receiving element 406. A controller 1002 may be configured to control the OPEN and CLOSED state of the switch S1. Accordingly, switch S1 can selectively short circuit power receiving element 406. The embodiment shown in FIG. 10 may be suitable if, for example, re-radiation is tolerable from the vertical power receiving elements 402, 404 but not from power receiving element 406.

For example, in a vertical charging field (e.g., FIG. 6), the controller 1002 may operate the switch in the OPEN state so that power induced in power receiving element 406 can be provided at output Vₒᵤₜ. In this case, re-radiation that may arise from the vertical power receiving elements 402, 404 may be deemed to be tolerable.

On the other hand, in a horizontal charging field (e.g., FIG. 7A), power induced in the vertical power receiving elements 402, 404 can be provided at output Vₒᵤₜ. However, re-radiation from power receiving element 406 may be deemed intolerable or otherwise undesirable. Accordingly, the controller 1002 may operate the switch S1 in the CLOSED state to short circuit power receiving element 406 in order to prevent any re-radiation from power receiving element 406 that may result from current induced in the vertical power receiving elements 402, 404.

In some embodiments, the controller 1002 may be configured to communicate with a source (e.g., wireless power transfer system 600, FIG. 6) of the charging field to determine the kind of charging field that will be generated by the wireless power transfer system. If the wireless power transfer system generates a vertical charging field (e.g., FIG. 6A), the controller 1002 can operate the switch S1 in the OPEN state. If the wireless power transfer system generates a horizontal charging field (e.g., FIG. 7A), the controller 1002 can operate the switch S1 in the CLOSED state.

FIG. 10 further illustrates that in other embodiments, receiver 10 may further include a voltage sensor circuit 1004 configured to measure or otherwise sense the voltage produced at the output Vₒᵤₜ. The controller 1002 may be configured to operate switch S1 in the OPEN state and then in the CLOSED state, making note of the voltage at the output Vₒᵤₜ for each switch state. The controller 1002 may operate switch S1 to the OPEN or CLOSED state depending on which switch state produces the higher voltage.

In some embodiments, several sections of power receiving elements may be switched. FIG. 10A, for example, shows a receiver 10′ comprising power receiving elements 402, 404, 406. A switch S1 may be controlled to short circuit the horizontal power receiving element 406. A switch S2 may be controlled to short circuit the vertical power receiving elements 402, 404. A controller 1002′ may operate either switch 51, S2 according to the kind of wireless power transfer system (e.g., 600, FIG. 6, 700, FIG. 7) that the receiver 10′ is being used with. The embodiments shown in FIG. 10A may be suitable if, for example, re-radiation of magnetic fields is not desirable from any of the power receiving elements 402, 404, 406.

Referring to FIG. 10A-1, for example, when the receiver 10′ determines that it is going to charge with a source (e.g., wireless power transfer system 600, FIG. 6) that generates a vertical charging field (e.g., FIG. 6A), the controller 1002′ may operate switch S1 to the OPEN state and switch S2 to the CLOSED state. For example, the controller 1002′ may communicate with the wireless power transfer system to determine that the charging field is vertically oriented. In this state, power at output Vₒᵤₜ comes from current induced in power receiving element 406. In addition, current induced in power receiving element 406 will bypass power receiving elements 402, 404 by virtue of switch S2 being in the CLOSED state, thus avoiding re-radiation of magnetic fields from power receiving elements 402, 404.

Conversely, with reference to FIG. 10A-2, when the source (e.g., wireless power transfer system 700, FIG. 7) generates a horizontal charging field (e.g., FIG. 7A), the controller 1002′ may operate switch S1 to the CLOSED state and switch S2 to the OPEN state. For example, the controller 1002′ may communicate with the wireless power transfer system and determine that the charging field is horizontally oriented. When switch S1 is CLOSED and switch S2 is OPEN, power at output Vₒᵤₜ comes from current induced in power receiving elements 402, 404.

In addition, current induced in power receiving elements 402, 404 will bypass power receiving element 406 by virtue of switch S1 being in the CLOSED state, thus avoiding re-radiation of magnetic fields from power receiving element 406.

FIG. 10A further illustrates that in other embodiments, receiver 10′ may further include voltage sensor circuit 1004 to measure or otherwise sense the voltage produced at the output Vₒᵤₜ. The controller 1002′ may be configured to operate switches S1, S2 in different combinations of OPEN and CLOSED state, and make note of the voltage at the output Vₒᵤₜ for each combination. The controller 1002′ may operate switches S1, S2 to the combination of OPEN and CLOSED state that produces the highest voltage, and hence power, at the output Vₒᵤₜ. More generally, the controller 1002 may try different combinations of OPEN and CLOSED state of switches S1 and S2 to identify a desired output voltage (e.g., highest voltage) at output Vₒᵤₜ.

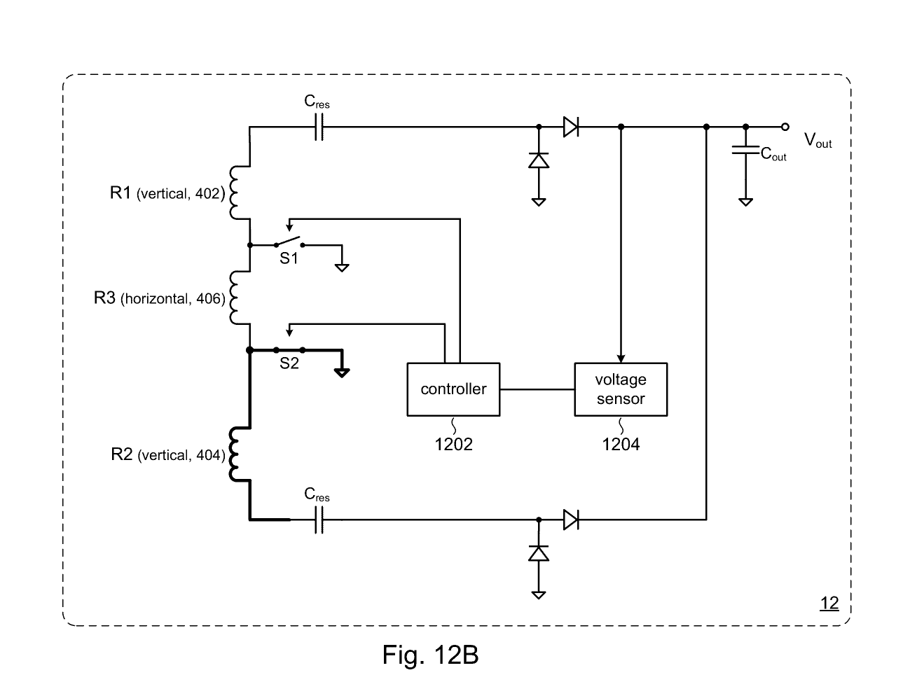

In accordance with the present disclosure, the power receiving elements 402, 404, 406 may be arranged in sections that can be selectively connected to the output using active devices (e.g., switches). FIG. 11, for example, shows a receiver 11 having a configuration of power receiving elements 402, 404, 406 in accordance with some embodiments. The configuration, for example, may include a first power component 1102 comprising the vertical power receiving elements 402, 404 and a tuning circuit Cᵣₑₛ. It will be appreciated that the tuning circuit may comprise elements (e.g., reactive elements) in addition to, or in place of, Cᵣₑₛ. The configuration may further include a second power component 1104 comprising the horizontal power receiving element 406 and a tuning circuit Cᵣₑₛ, although in other embodiments the tuning circuit may comprise elements (e.g., reactive elements) in addition to, or in place of, Cᵣₑₛ. In some embodiments, power components 1102, 1104 may comprise resonant circuits for wireless power transfer, as FIG. 11 shows. Persons of ordinary skill, however, will appreciate that other embodiments may use non-resonant implementations for wireless power transfer. Accordingly, in some embodiments the tuning circuit Cᵣₑₛ may be omitted from either or both power components 1102, 1104.

A switch S1 may selectively connect first power component 1102 or second power component 1104 to a rectifier 1114 to provide a rectified output to smoothing capacitor Cₒᵤₜ. A controller 1112 may operate the switch S1. The switch S1 may serve to electrically isolate power components 1102, 1104 from each other. The configuration shown in FIG. 11 can maximize output efficiency because, at any given time, only one section (e.g., first power component 1102) is connected to the output Vₒᵤₜ. Since the other section (e.g., second power component 1104) is disconnected from the output Vₒᵤₜ, its output will not compete with the output of the selected section.

In operation, the power receiving element(s) that have the most induced current will contribute most of the power at the output Vₒᵤₜ. For example, in a predominantly vertical charging field (e.g., FIG. 6A), the horizontal power receiving element 406 may experience the most induced current and so the output at second power component 1104 would be greater than at first power component 1102. Likewise, in a predominantly horizontal charging field (e.g., FIG. 7A), the vertical power receiving elements 402, 404 may experience the most induced current and so the output at first power component 1102 would be greater than at second power component 1104.

In some embodiments, the controller 1112 may be configured to communicate with a source (e.g., wireless power transfer system 600, FIG. 6, 700, FIG. 7) to determine the kind of charging field that will be generated by the wireless power transfer system. For example, if the wireless power transfer system generates a vertical charging field (e.g., FIG. 6A), the controller 1112 can operate the switch S1 to connect resonator 1104 to the output Vₒᵤₜ. If the wireless power transfer system generates a horizontal charging field (e.g., FIG. 7A), the controller 1112 can operate the switch S1 to connect first power component 1102 to provide wirelessly received power at the output Vₒᵤₜ.

FIG. 11 further illustrates that in other embodiments, receiver 11 may further include a voltage sensor circuit 1114 configured to measure or otherwise sense the voltage produced at the output Vₒᵤₜ. The controller 1112 may be configured to operate switch S1 to connect to the power components 1102, 1104 to the output Vₒᵤₜ to measure their respective individual voltages. The controller 1112 may operate switch S1 to electrically connect either the first or second power component 1102, 1104 to the output Vₒᵤₜ depending on which produces the higher voltage.

In some embodiments, additional resonator sections may be provided. FIG. 11A, for example, shows a receiver 11′ comprising three power components 1102′ (comprising power receiving elements R1, R2), 1104′ (comprising power receiving element R3), 1106′ (comprising power receiving element R4). For example, the receiver 11′ may be a small irregular device (e.g., wearable device 50, FIG. 5A). The receiver 11′ may include a three-way switch S2 that can selectively connect any one of the power components 1102′, 1104′, 1106′ to the output Vₒᵤₜ in response to a controller 1112′. Each power component 1102′, 1104′, 1106′, for example, may be configured in a plane at different angles relative to each other; e.g., at right angles to each other in X-, Y-, and Z-planes.

Controller 1112′ may include an orientation sensor 1114′ that provides information about the placement orientation of the receiver 11′ on a charging surface (not shown). The controller 1112′ may be configured to operate switch S2 to connect an appropriate power component 1102′, 1104′, 1106′ to the output Vₒᵤₜ depending on which the placement orientation of the receiver 11′ on the charging surface. For example, suppose the receiver 11′ is a wearable device (e.g., 50, FIG. 5A) and power receiving element R4 lies in the plane of the face of the wearable device. If the controller 1112′ detects that the receiver 11′ is placed face down on a charging surface, the controller 1112′ may operate switch S2 to connect power component 1106′ to the output Vₒᵤₜ. In some embodiments, the controller 1112′ may also be configured to communicate with a wireless power transfer system (e.g., 600, FIG. 6, 700, FIG. 7) to determine the kind of charging field that will be generated by the wireless power transfer system; e.g., a horizontally oriented charging field, a vertically oriented charging field, etc. The controller 1112′ may use both the placement orientation (e.g., provided by orientation sensor 1114′) and the charging field orientation to connect an appropriate power component 1102′, 1104′, 1106′ to the output Vₒᵤₜ.

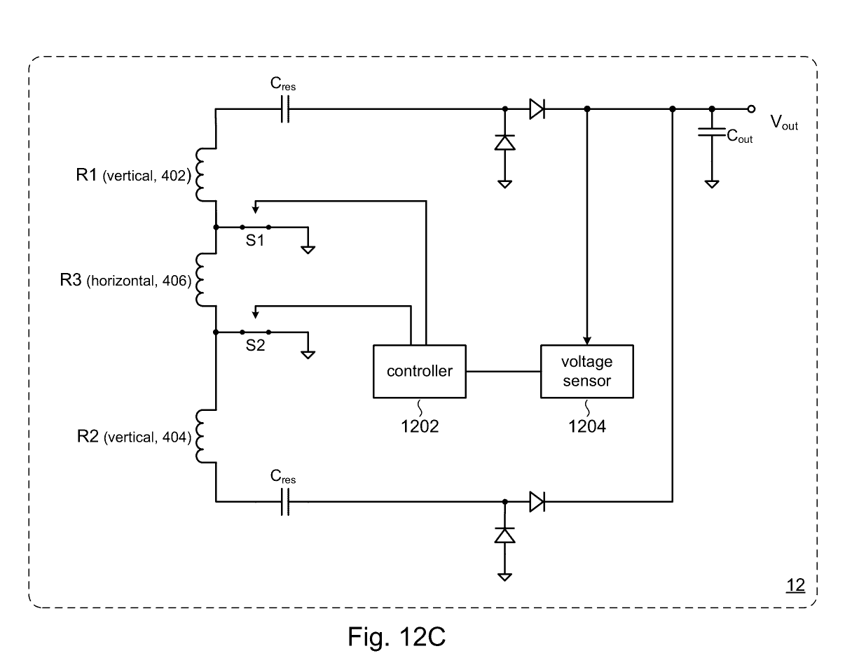

Referring to FIG. 12, in accordance with the present disclosure, the power receiving elements 402, 404, 406 may be arranged as sections that can be selectively shorted using active devices and diode-OR'd together at the output Vₒᵤₜ. In some embodiments, the power receiving elements 402, 404, 406 in a receiver 12 may include switches S1 and S2 between the power receiving elements 402, 404, 406. A voltage sensor circuit 1204 may be configured to measure or otherwise sense the voltage produced at the output Vₒᵤₜ. A controller 1202 may operate the switches S1 and S2 in the OPEN or CLOSED states.

In some embodiments, for example, the controller 1202 may be configured to communicate with a source (e.g., wireless power transfer system 600, FIG. 6, 700, FIG. 7) to determine the kind of charging field that will be generated by the wireless power transfer system. For example, if the wireless power transfer system generates a vertical charging field (e.g., FIG. 6A), the controller 1202 can operate both switches S1, S2 in the OPEN state, as shown in FIG. 12, allowing the horizontal power receiving element 406 to couple with the charging field to wirelessly receive power, which can then be provided to output Vₒᵤₜ.

If the controller 1202 determines that the wireless power transfer system generates a horizontal charging field (e.g., FIG. 7A), the controller 1202 may be configured to determine if one of the vertical power receiving elements 402, 404 is closer to the wireless power transfer system than the other. For example, the controller 1202 may operate switch S1 in the CLOSED state and switch S2 in the OPEN state, as shown in FIG. 12A and note the voltage at Vₒᵤₜ using voltage sensor 1204. The controller 1202 may then operate S1 in the OPEN state and switch S2 in the CLOSED state, as shown in FIG. 12B and note the voltage at Vₒᵤₜ.

If one switch configuration (FIGS. 12A, 12B) produces a higher voltage than the other, then the controller 1202 may select that switch configuration. For example, FIG. 7A shows that the receiver 70 is placed so that power receiving element 404 is closer to large device 700 than power receiving element 402, and thus may couple more strongly to the charging field than either of power receiving elements 402, 406; power receiving element 406 should have very little coupling because of the horizontal charging field. Accordingly, controller 1202 may select the switch configuration shown in FIG. 12B to provide power at the output Vₒᵤₜ.

If both switch configurations produce roughly an equal voltage, then the controller 1202 may operate both switches S1 and S2 to the CLOSED state, as shown in FIG. 12C. In this switch configuration, power may be provided via power receiving elements 402 and 404.

In some embodiments, a threshold voltage V_{threshold} may be used to determine whether to use the switch configuration shown in FIG. 12C. For example, if the difference between the voltages measured for the switch configuration of FIG. 12A and the switch configuration of FIG. 12B is less than V_{threshold}, then the controller 1202 may select the switch configures of FIG. 12C. Otherwise, the controller 1202 may select the switch configuration (FIG. 12A, 12B) that produces the higher voltage.

The switch configuration shown in FIGS. 12A and 12B may limit magnetic field re-radiation from the horizontal power receiving element 406 in the presence of a horizontal charging field (e.g., FIG. 7A). Consider FIG. 12B, for example; if the vertical power receiving element 404 is closer to the charging field than is vertical power receiving element 402 (e.g., FIG. 7A), then the induced current in vertical power receiving element 404 may be greater than in vertical power receiving element 402 (as illustrated by the darkened line in FIG. 12B). Closing switch S2 can prevent the induced current flow in vertical power receiving element 404 from creating a current flow in horizontal power receiving element 406 by providing a path to ground for the induced current in vertical power receiving element 404, thus bypassing the power receiving element 406, and hence prevent re-radiation from horizontal power receiving element 406. On the other hand, an induced current flow in vertical power receiving element 402 may still cause a flow of current in horizontal power receiving element 406. However, the current flow in vertical power receiving element 402 may be small enough that any resulting re-radiation from horizontal power receiving element 406 may be deemed acceptable. A similar discussion applies to the switch configuration of FIG. 12A, where the roles of vertical power receiving elements 402 and 404 may be reversed.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. An electronic device comprising:
a plurality of power receiving elements, each power receiving element configured to electromagnetically couple to an externally generated magnetic field to receive power wirelessly;
a plurality of switches connected to the plurality of power receiving elements; and
an output circuit configured to provide wirelessly received power to the electronic device,
the plurality of switches configured to selectively short circuit at least one of the plurality of power receiving elements.

2. The device of claim 1, wherein some of the plurality of power receiving elements are arranged in different geometric planes.

3. The device of claim 1, wherein one of the plurality of power receiving elements has an orientation so as to electromagnetically couple more strongly to an externally generated magnetic field having field lines in a first orientation than to an externally generated magnetic field having field lines in a second orientation.

4. The device of claim 1 being a handheld device, wherein one of the plurality of power receiving elements is disposed on a major surface of the handheld device and one of the plurality of power receiving elements is disposed on a side surface of the handheld device.

5. The device of claim 1 being a wearable device, wherein one of the plurality of power receiving elements is disposed on a face of the wearable device and one of the plurality of power receiving elements is disposed on a fastener of the wearable device.

6. The device of claim 1, wherein the plurality of power receiving elements are connected in series.

7. The device of claim 1, wherein the at least one power receiving element is short circuited to a ground reference.

8. The device of claim 1, further comprising a controller configured to operate the plurality of switches.

9. The device of claim 8, wherein the controller is configured to communicate with a source of the externally generated magnetic field and operate the plurality of switches as a consequence of the communication.

10. The device of claim 8, further comprising a voltage sensor configured to detect a voltage of the output circuit, the controller further configured to short circuit one or more of the plurality of power receiving elements depending on which combination of the plurality of power receiving elements provides the highest voltage at the output circuit.

11. The device of claim 1, further comprising a tuning circuit electrically connected to the plurality of power receiving elements to define a resonator.

12. The device of claim 1, further comprising a resonator and a rectifier circuit electrically connected to the resonator to produce a rectified output.

13. The device of claim 1, wherein each power receiving element is a coil of electrically conductive material.

14. A method for receiving power wirelessly in an electronic device comprising:
selecting one or more first power receiving elements from a plurality of series-connected power receiving elements disposed in the electronic device;
selecting one or more second power receiving elements from the plurality of series-connected power receiving elements;
electromagnetically coupling the one or more first power receiving elements to an externally generated magnetic field to receive power wirelessly including inducing a flow of current in the one or more first power receiving elements with the externally generated magnetic field and bypassing the flow of current around the one or more second power receiving elements; and
providing wirelessly received power received by the one or more first power receiving elements to the electronic device.

15. The method of claim 14, further comprising communicating with a source of the externally generated magnetic field to determine an orientation of the externally generated magnetic field, wherein selecting one or more first power receiving elements and selecting one or more second power receiving elements are based on the orientation of the externally generated magnetic field.

16. The method of claim 14, wherein selecting the one or more first power receiving elements includes determining that the one or more first power receiving elements produces the most power among the plurality of power receiving elements.

17. The method of claim 14, further comprising shorting together the one or more second power receiving elements.

18. The method of claim 14, wherein the plurality of power receiving elements comprise a plurality of coils, some of which are arranged in different geometric planes.

19. An electronic device comprising:
a first power receiving element configured to electromagnetically couple to a first type of externally generated magnetic field having a first orientation to receive power wirelessly;
a second power receiving element configured to electromagnetically couple to the first type of externally generated magnetic field to receive power wirelessly;
a third power receiving element configured to electromagnetically couple to a second type of externally generated magnetic field having a second orientation to receive power wirelessly, the third power receiving element connected in series with the first and second power receiving elements; and
a plurality of switches configured to selectively ground one end of the first power receiving element or the second power receiving element to reduce re-radiation of a magnetic field by the third power receiving element when in the presence of the first type of externally generated magnetic field.

20. The device of claim 19, wherein the first and second power receiving elements electromagnetically couple more strongly to the first type of externally generated magnetic field than to the second type of externally generated magnetic field, wherein the third power receiving element electromagnetically couples more strongly to the second type of externally generated magnetic field than to the first type of externally generated magnetic field.

21. The device of claim 19, wherein the first and second power receiving elements are arranged in geometric planes different from the third power receiving element.

22. The device of claim 19, wherein the third power receiving element is electrically connected between the first and second power receiving elements.

23. The device of claim 19 being a handheld device, wherein the first and second power receiving elements are arranged on sides of the handheld device and the third power receiving element is arranged on a major surface of the handheld device.

24. The device of claim 19 being a wearable device, wherein the first and second power receiving elements are arranged on a fastener of the wearable device and the third power receiving element is arranged on a face of the wearable device.

25. A method for receiving power wirelessly in an electronic device comprising:
electromagnetically coupling a first power receiving element and a second power receiving element to an externally generated magnetic field to receive power wirelessly;
electromagnetically coupling a third power receiving element to the externally generated magnetic field, the first and second power receiving elements electromagnetically coupling more strongly to the externally generated magnetic field than does the third power receiving element; and
preventing a current induced in the first power receiving element from producing a flow of current in the third power receiving element to reduce re-radiation of a magnetic field by the third power receiving element.

26. The method of claim 25, further comprising closing a switch connected between one end of the first power receiving element and a ground potential to prevent the current induced in the first power receiving element from producing a flow of current in the third power receiving element.

27. The method of claim 25, further comprising allowing a current induced in the second power receiving element to produce a flow of current in the third power receiving element, wherein the current induced in the first power receiving element is greater than the current induced in the second power receiving element.

28. The method of claim 27, further comprising opening a switch connected between one end of the second power receiving element and a ground potential to allow the current induced in the second power receiving element to produce a flow of current in the third power receiving element.

29. The method of claim 25, wherein the third power receiving element is connected in series between the first and second power receiving elements, the method further comprising grounding one end of the first power receiving element to prevent the current induced in the first power receiving element from producing a flow of current in the third power receiving element.
